(19) United States
(12) Patent Application Publication
(10) Pub. No.: US 2006/0267335 A1
(43) Pub. Date: Nov. 30, 2006

(54) BOOK CORNER PROTECTOR

(76) Inventor: DANETHRA C. THOMAS, St. Louis, MO (US)

Correspondence Address: CHARLES C. MCCLOSKEY, 763 S. NEW BALLAS ROAD STE. 170, ST. LOUIS, MO, 63141, US

(21) Appl. No.: 11/419,795

(22) Filed: May 23, 2006

Related U.S. Application Data
(60) Provisional application No. 60/684,155, filed on May 24, 2005.

(51) Int. Cl. B42D 1/00

(52) U.S. Cl. 281/20

(57) ABSTRACT

Generally, the book corner protector preserves the covers of paperback books from bending and detaching. The protector has a triangular or rectangular shape sealed on two edges forming a pocket. Upon the interior of the pocket, the protector has one or more lines of adhesive. In use, the protector is positioned near a corner of a paperback book. The corner is inserted through the open edges of the pocket until the two sealed edges of the protector abut the corner. Applying pressure to the protector activates the adhesive, thus securing the protector to the book corner.

### CROSS REFERENCE TO RELATED APPLICATION

This non-provisional application claims priority to the provisional application for patent Ser. No. 60/684,155 which was filed on May 24, 2005 and is commonly owned by the same inventor.

### BACKGROUND OF THE INVENTION

The book cover protector relates generally to book binding and more specifically to a reinforcing piece placed upon a corner of a book.

Information and entertainment are provided in many forms including print. In print, books provide news and stories, information and entertainment, to thousands of readers. Publishers print books generally in hardcover and paperback editions. The hardcover editions fetch a higher selling price than paperback and have higher durability. Most textbooks are provided with a hardcover. Book collectors, libraries, students, schools, and universities often purchase hardcover editions.

Focusing on the students and those who read for entertainment, publishers provide paperback editions of books. The paperbacks have an economical price for students who use their books thoroughly while studying and may use them later occasionally as references. For entertainment readers, paperbacks have an acceptable price for a book that may be read in portions over a long time. A paperback book may strike the fancy of a reader who desires to read it again or to keep it for reference.

However, paperback books have flexible covers to lower their price and weight. Through use and placement in a student's backpack or a reader's bag, the typical paperback book suffers bent corners. With sufficient bending, the corners permanently curl or even break off from the cover. A paperback book with curled or missing corners does not look attractive and may expose book pages to further abuse.

### DESCRIPTION OF THE PRIOR ART

A paperback book cover generally has a rectangular shape though other shapes appear from time to time. Rectangular shapes have been protected in the prior art. For example, the patent to Leander, U.S. Pat. No. 2,728,451 has a triangular shaped paper with an adhesive folded in half. The resulting triangular shaped protector is then placed upon the corners of sheet metal for transportation and handling. The triangular protector guards the corners of sheet metal from bending. This patent though does not secure the protector with a pocket. Rather one side of the protector adheres to metal and the other side is compressed beneath adjacent sheets of metal.

Then the patents to Lee, U.S. Pat. Nos. 5,533,758 and 5,626,366 provide a book cover corner guard. These guards have a generally planar shape with adhesive applied upon one side. The guards adhere to the corners of a book and stiffen the corners as a result. However, the guards only attach to an exterior surface of a cover.

In a similar area, the patent to Chariton et al., U.S. Pat. No. 5,000,361 has a protective cover for file folders. The cover has a durable material construction with center score lines to match the fold of a file folder. The cover has tabs folded over on three sides to secure a file folder within the cover. This cover lacks sufficient width in the center for the spine of a book.

The patents to Yeh, U.S. Pat. Nos. 5,474,332 and 5,622,385 provide a wraparound book cover. The cover is a single piece of flexible plastic with scoring to fit multiple thicknesses and sizes of books. The cover folds over an existing book cover to encase its outer edges. Clips secure the folded ends of the cover into pockets in which the book covers rest. An elastic band secures the cover and the book in a closed position. This cover protects areas of a paperback that endure little damage.

The present invention overcomes the difficulties of covering too much of a book, protecting only the exterior, and having an incomplete pocket. The present invention covers the corners of a book that sustain damage, both sides of the corner, and forms a pocket secured on at least two edges.

### SUMMARY OF THE INVENTION

Generally, the present invention provides a book corner protector for preserving the covers of paperback books. The protector has a triangular or rectangular shape sealed on two edges forming a pocket. Upon the interior of the pocket away from the open edges, the protector has one or more lines of adhesive. In use, the protector is positioned near a corner of a paperback book. The corner is inserted through the open edges until the two sealed edges abut the corner. Applying pressure to the protector activates the adhesive, thus securing the protector to the book corner.

There has thus been outlined, rather broadly, the more important features of the invention in order that the detailed description thereof that follows may be better understood and that the present contribution to the art may be better appreciated.

Further, the present invention also includes triangular and rectangular forms with one or more internal lines of adhesive. The adhesive can be applied directly to one surface or be applied in tape form.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved book cover protector.

Another object is to provide such a protector with rigidity to deter bending of the corners of a paperback book.

Another object is to provide such a protector readily attached to paperback book covers.

Another object is to provide such a protector that can be easily and efficiently manufactured and marketed to the consuming public.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 shows the preferred embodiment of the present invention constructed in accordance with the principles of the present invention;

FIG. 2 shows an end view of the pocket of the preferred embodiment of the present invention;

FIG. 3 shows an alternate embodiment of the present invention;

FIG. 4 describes an end view of the pocket of the alternate embodiment;

FIG. 5 illustrates a sleeve prepared to manufacture the preferred embodiment;

FIG. 6 describes a sheet prepared with adhesive and a fold to form a sleeve;

FIG. 7 illustrates a sleeve prepared from the sheet for manufacturing the alternate embodiment;

FIG. 8 illustrates the preferred embodiment in use; and,

FIG. 9 illustrates the alternate embodiment in use.

The same reference numerals refer to the same parts throughout the various figures.

### DESCRIPTION OF THE PREFERRED EMBODIMENT

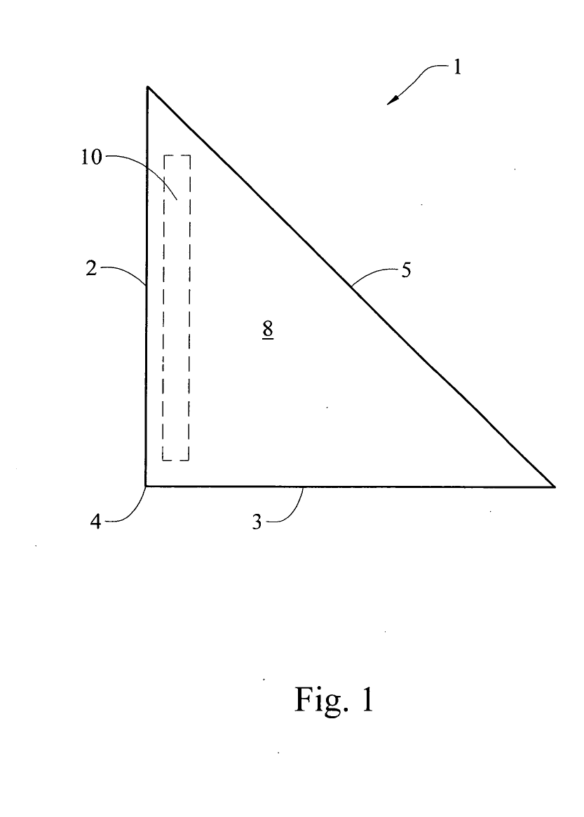

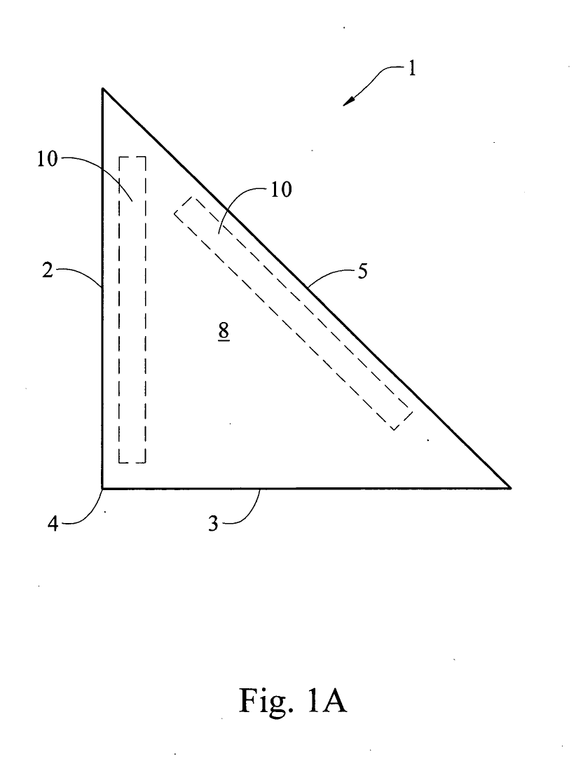

The present art overcomes the prior art limitations by providing a book cover protector forming a pocket having adhesive contained therein. Beginning on FIG. 1, the preferred embodiment of the book cover protector 1 has a triangular shape, more particularly a right triangle. The present invention has two sealed perpendicular edges 2, 3 forming an interior corner 4. Opposite the interior corner as the hypotenuse 5, the present invention has an open edge forming a pocket 6. FIG. 1 shows the top surface 8 of the present invention and the pocket 6 forms between the top surface 8 and the opposite bottom surface 9. Upon one or both edges inside the pocket upon the top surface, the present invention has a line of adhesive 10. The adhesive 10 extends partially along the edge 2 but does not reach the limits of the edge. In the preferred embodiment the adhesive is pressure sensitive and is applied in a spaced interval along a line.

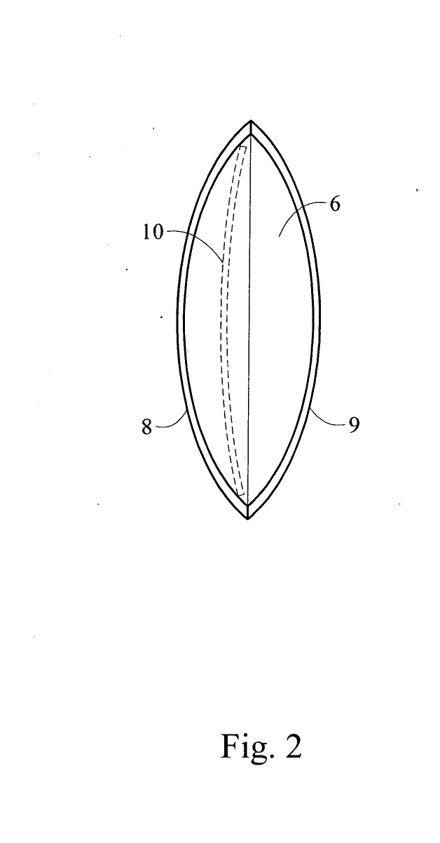

Turning the present invention, FIG. 2 shows the pocket 6 formed to receive the corner of a paperback book. In the preferred embodiment, the line of adhesive 10 appears towards the rear of the pocket 6 upon the top surface 8, generally the left in FIG. 2. Pressing the ends of the pocket towards each other extends the top surface and the bottom surface outwards allowing the corner of a book cover to enter the present invention.

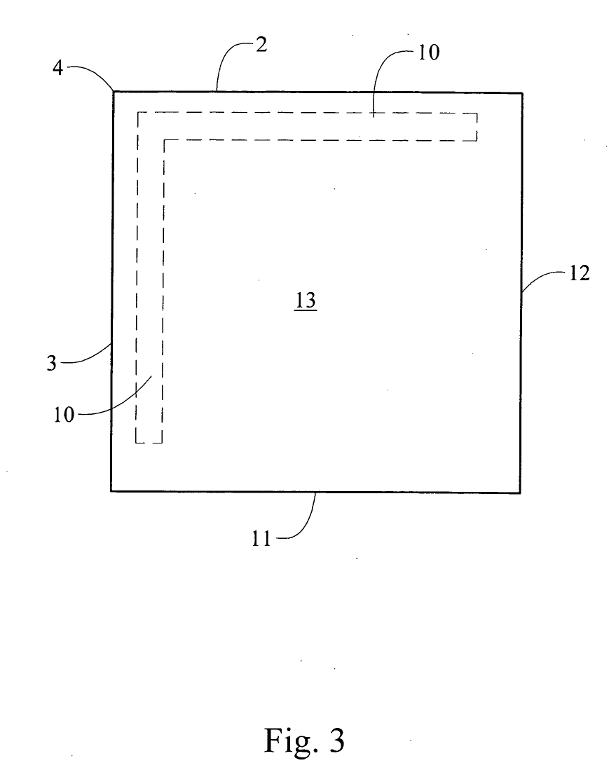

FIG. 3 shows an alternate embodiment of the present invention. The alternate embodiment has a rectangular shape, more particularly a square. The present invention has two sealed perpendicular edges 2, 3 forming an interior corner 4. Opposite the interior corner of the sealed edges, the alternate embodiment has two perpendicular open edges 11, 12 that form a pocket 6. FIG. 3 shows the top surface 13 of the alternate embodiment and the pocket forms between the top surface and the opposite bottom surface 14. Upon both edges inside the pocket upon the top surface, the alternate embodiment has a line of adhesive 10. The adhesive extends partially along the edge but does not reach the limits of the edge.

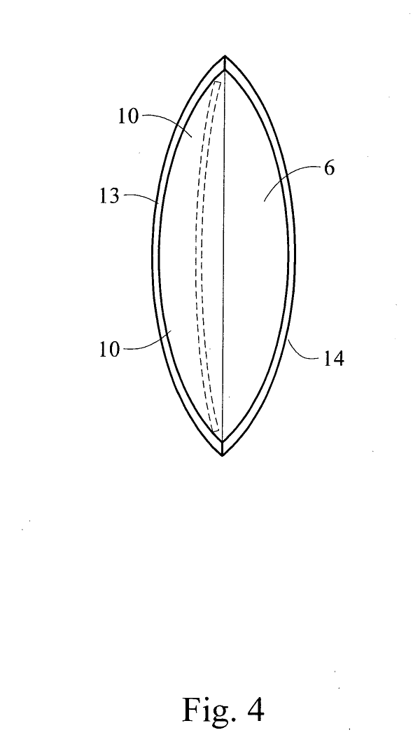

Turning the present invention, FIG. 4 shows the pocket formed to receive the corner of a paperback book. In the alternate embodiment, the lines of adhesive appear towards the rear of the pocket upon the top surface, generally the left in FIG. 4. Pressing the ends of the pocket towards each other extends the top surface and the bottom surface outwards allowing the corner of a book cover to enter the present invention.

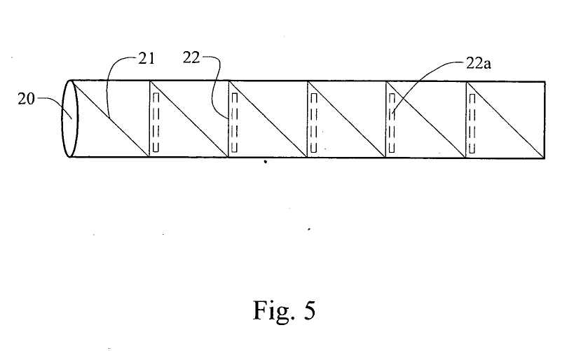

FIG. 5 illustrates the manufacture of the preferred embodiment of the present invention. The present invention begins as a sleeve 20 of material with an open end. The sleeve is then cut in a regular pattern on a diagonal line 21 to form the hypotenuse of the preferred embodiment and on a line 22 across the sleeve to separate duplicates of the invention. The sleeve is simultaneously sealed 22a adjacent to the line across the sleeve. As duplicates of the invention are freed from the sleeve, adhesive is inserted within the pocket underneath the top face.

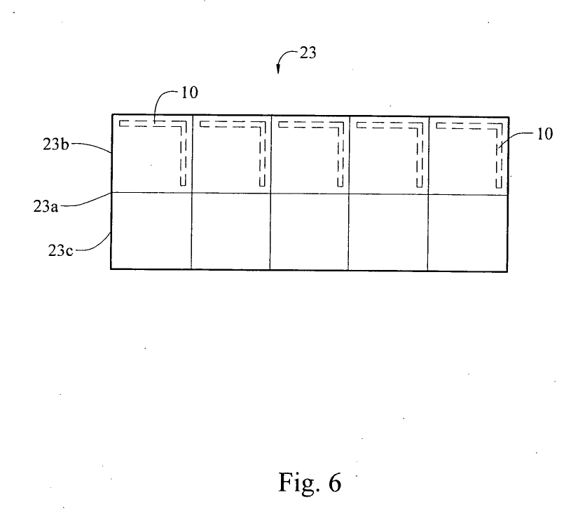

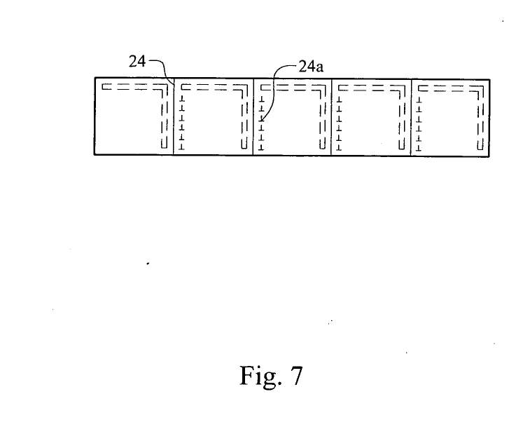

The alternate embodiment is manufactured as begun in FIG. 6. The alternate embodiment starts as a sheet 23 with a central longitudinal fold line 23a. Upon one half 23b of the sheet above the fold line, adhesive 10 is applied in a line along the outer edge of the sheet away from the fold line and in a pattern of lines spaced across the width of half sheet 23b. The manufacturing then progresses as the half 23c of the sheet below the fold line is folded upon the other half 23b keeping the adhesive inside the sheet turned into a sleeve. As in FIG. 5, the now formed sleeve is then sealed along a pattern of lines 24a and in a pattern of cuts 24 across the sleeve to separate duplicates of the alternate embodiment of the present invention.

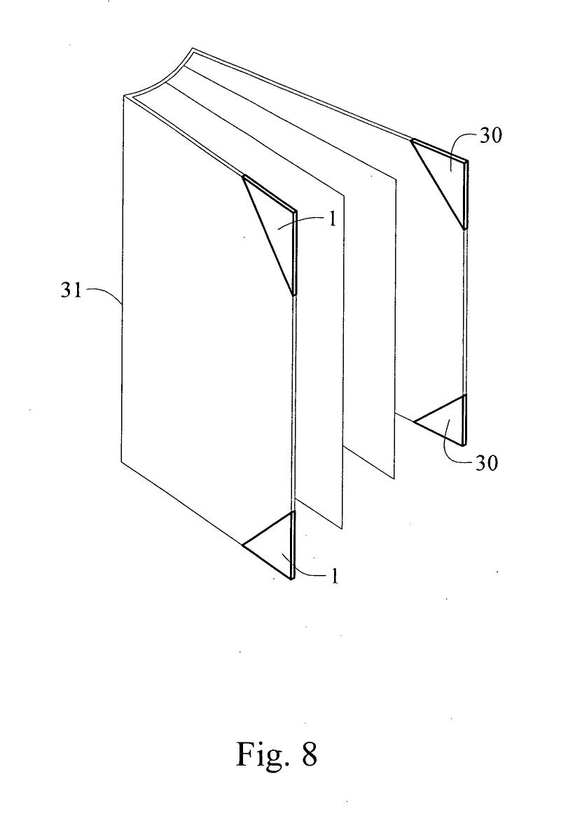

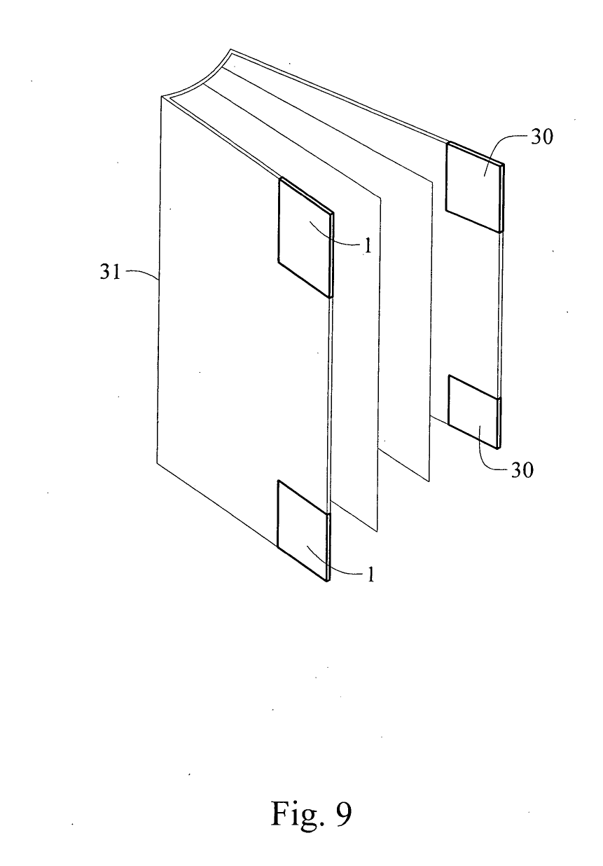

In use, the present invention appears in the preferred embodiment in FIG. 8. The triangular shape of the preferred embodiment allows for ready installation of the invention upon the four corners 30 of a paperback book cover away from the spine 31. The present invention fits over the corners and has sufficient size to protect the corner and a portion of the remaining cover to deter folding of the corners. The alternate embodiment of the present invention appears as used in FIG. 9. The rectangular shape of the preferred embodiment installs with care upon the corners 30 of a paperback book cover. As before, the alternate embodiment fits over the corners, has a shape similar to the book cover, and has enough size to deter folding of a corner and to protect a corner.

From the aforementioned description, a book cover protector has been described. The book cover protector is uniquely capable of preventing permanent turning and fraying of paperback book corners. The book cover protector and its various components may be manufactured from many materials, including but not limited to paper, cardstock, cardboard, polymers, high density polyethylene, polypropylene, polystyrene, nylon, ferrous and non-ferrous metal foils, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A device, used singly or in plural, to protect the corners of a book comprising:
a top surface having perimeter edges;
an opposite bottom surface of the same shape as said top surface and having perimeter edges;
said top surface and said bottom surface joining upon at least two edges forming a pocket and an interior corner; and,
at least one portion of adhesive within said pocket;
thus a corner of a book cover is inserted into said pocket and said top surface is pressed upon the corner and said adhesive binds the book cover to said device.

2. The book corner protector of claim 1 wherein said top surface and said bottom surface have a right triangular shape with a hypotenuse and said pocket opens along the hypotenuse opposite said interior corner and one line of said adhesive is applied to said top surface.

3. The book corner protector of claim 1 wherein said top surface and said bottom surface have a rectangular shape and said pocket opens upon the two edges opposite said interior corner and at least two perpendicular lines of said adhesive are applied to said top surface.

4. The book corner protector of claim 3 wherein said top surface and said bottom surface have a square shape.

5. The book corner protector of claim 1 wherein said adhesive is pressure sensitive.

6. A method of forming a triangular device, used singly or in plural, to protect the corners of a book, comprising:
1) extending a sleeve of material;
2) cutting said sleeve on a diagonal line;
3) sealing said sleeve on a line across said sleeve from the end of the diagonal line to the opposite edge of said sleeve;
4) cutting across said sleeve on a line adjacent to the sealed line forming the second side of said protector; and,
5) removing said protectors as cut from said sleeve.

7. A method of forming a rectangular device, used singly or in plural, to protect the corners of a book, comprising:
1) extending a sheet of flat material having a central longitudinal fold line and perimeter edges;
2) applying adhesive along one edge of said sheet;
3) folding said sheet upon said fold line thus forming a sleeve;
4) sealing said sleeve on a line across said sleeve at the same interval as said adhesive;
5) cutting across said sleeve adjacent to said adhesive; and,
6) removing said protectors as cut from said sleeve
